(19) United States
(12) Patent Application Publication
(10) Pub. No.: US 2003/0118977 A1
(43) Pub. Date: Jun. 26, 2003

(54) System for teaching about an apparatus provided with a plurality of functionalities, an apparatus involved in such a system and a method implemented in such a system

(76) Inventor: Sandra Oudejans, Le Mans (FR)

Correspondence Address: PHILIPS ELECTRONICS NORTH AMERICAN CORP, 580 WHITE PLAINS RD, TARRYTOWN, NY, 10591, US

(21) Appl. No.: 10/304,130

(22) Filed: Nov. 25, 2002

(30) Foreign Application Priority Data
Nov. 30, 2001 (FR) 0115505

(51) Int. Cl. G09B 3/00

(52) U.S. Cl. 434/350; 434/362

(57) ABSTRACT

This system is intended for teaching about an apparatus (12) provided with a plurality of functionalities which the users have difficulty in exploring. This system is formed by a server device (5) for supplying, via the Internet (10), questions concerning the possibilities of said apparatus. Each correct response gives rise to the allocation of points and makes it possible to continue. The users who obtain the highest scores are rewarded. Thus, by virtue of this system, the users acquire good knowledge of the apparatus, which encourages their loyalty. In addition, by analyzing certain responses, the manufacturer knows the functionalities which he has to develop. Application: Teaching about apparatus with complex functionalities.

The invention also relates to an apparatus involved in such a system and a method for enhancing such an apparatus with users.

The invention also relates to a method for enhancing with users an apparatus having a plurality of functionalities.

The invention finds major applications in particular with regard to the development of a product and its enhancement with customers.

The invention relates in particular to apparatus having a functioning of a rather complex type, such as for example a mobile telephony apparatus. Very often the users use only a small part of the possibilities of their apparatus. In addition, it is important for the manufacturer of such apparatus to know which functionality is well understood and whether it is appreciated.

In PCT patent document WO 01/35687, means are proposed for facilitating the user in his attempts to access the various functionalities of the apparatus; however, this requires using all kinds of devices.

The present invention proposes a system of the type mentioned in the preamble which is differentiated to a large extent from the aforementioned prior art by encouraging the user to learn the functionalities of his apparatus himself.

For this purpose, such a system is characterized in that it is formed by a server device for providing questions concerning the possibilities of said apparatus, for attributing points to each user of the server device and for determining a reward for the users who have the most points.

A method for enhancing with users an apparatus having a plurality of functionalities is characterized in that it includes the following steps of:

putting on a server, of the Internet type in particular, a questionnaire concerning the use of the apparatus,

establishing a score for the correct responses to the questions in said questionnaire,

rewarding the best users, based on said score.

The invention will be further described with reference to examples of embodiment shown in the drawings to which, however, the invention is not restricted. In the drawings:

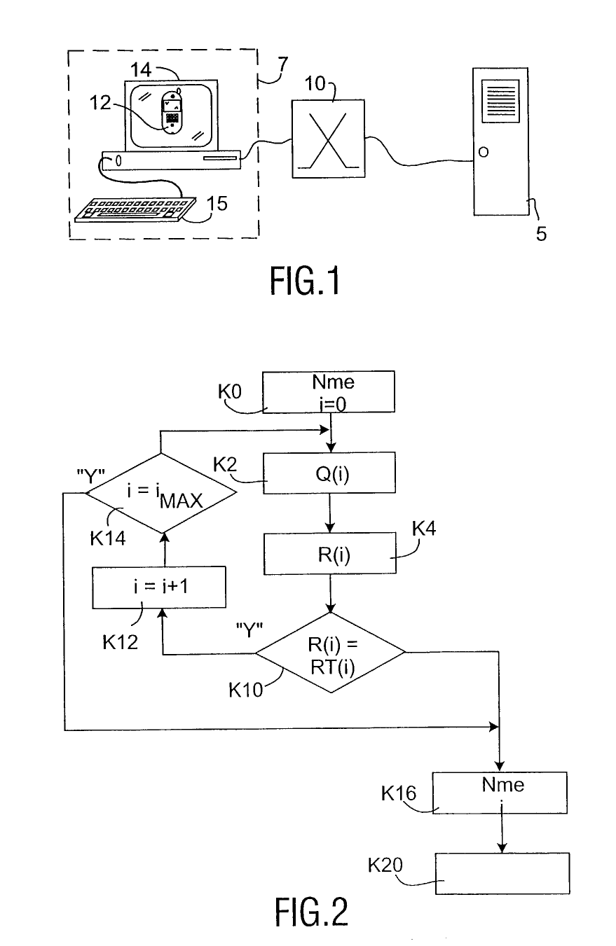

FIG. 1 shows a system according to the invention.

FIG. 2 shows a flow chart used in the system according to the invention.

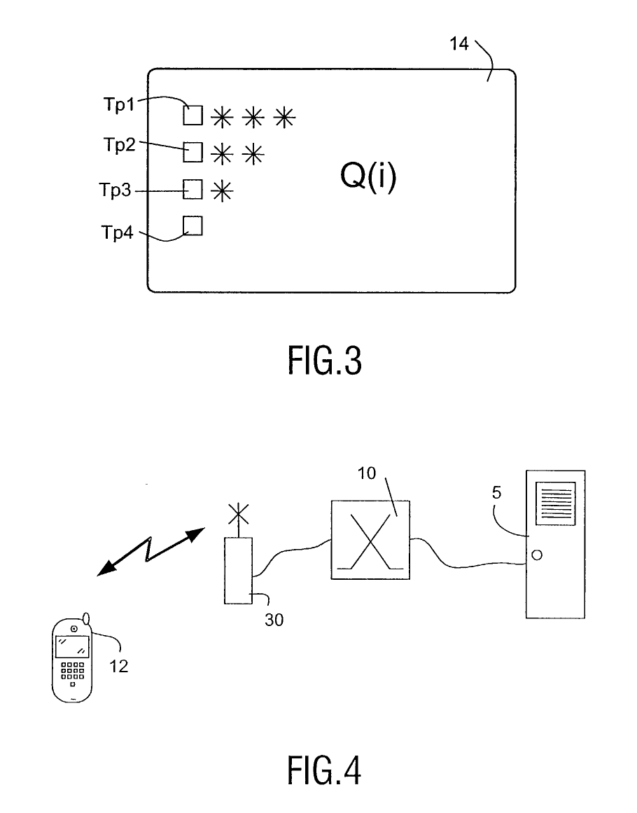

FIG. 3 shows a screen which shows a measurement recommended by the invention.

FIG. 4 shows another embodiment of the invention.

FIG. 1 shows a system according to the invention. It is composed of a server device 5 with which a terminal station 7 communicates. This server 5 offers a questionnaire, via the Internet 10, concerning an apparatus 12, which can be shown on the screen 14 of the terminal station 7. In the context of the example this apparatus 12 is a mobile telephone of the cellular type. The questionnaire which the user has sought from the terminal station 7 contains questions to which the responses can be made by means of the keyboard 15 or mouse (not shown). The questions will concern the functioning of the apparatus and the functionalities with which it is provided. In order that the user makes efforts to know his apparatus better, this questionnaire resembles a game with rewards which are provided for those who acquire the best possible knowledge of the apparatus.

FIG. 2 shows, by means of a flow chart, how this game can be organized. The box K0 is an initialization step. During this step an attempt is made to define, among other things, the profile of the user: his name “Nme”, his job, in what branch of industry he works etc. During this step, his score is initialized to the game-questionnaire offered to him. The box K2 corresponds to the submission of a question Q(i) and box K4 to the response R(i) given by the user. This response is tested with the specimen response RT(i) in box K10. If the response is correct, then box K2 is returned to through boxes K12 and K14. Box K12 has the effect of incrementing the number “i” of the question and box K14 is a test at the end of the questionnaire. If the test is finished, box K16 is then gone to. If the response is negative to the test of box K10, box K16 is also gone to. At this box K16, the name of the user “Nme” and the number of the last question to which he has responded are recorded. Box K20 shows the classification of the user among others. If his score is good (if he has responded to many questions), a reward can be granted to him either in the form of money, or by granting him time credit for the use of his radio telephone. It goes without saying that the user, attracted by the reward, will leaf through the method of use of the apparatus with a view to correctly responding to the questionnaire.

In order to determine the functionalities which interest the user, indicators are added to the questions concerning the functionalities, as shown in FIG. 3. These indicators consist of boxes to be ticked Tp1 to Tp4 shown on the screen 14 relating to a question Q(i). Opposite these boxes Tp1 to Tp4, asterisks * have been entered, the number of which is deemed to represent the interest of the question. An analysis of these responses will be taken into account for the development of a future apparatus.

FIG. 4, on which the elements common to those in the previous Figures bear the same references, shows another example of embodiment of the invention. In this example, the Internet is accessible to the mobile system, known by the term WAP. An interface circuit 30 makes it possible to collect and transmit information to the mobile apparatus 12, which thus makes it possible to directly access the game questionnaire.

It will be realized that the user who has devoted time to this questionnaire will be faithful to the apparatus and will be tempted to purchase new versions of this apparatus as soon as they come out.

1. A system for teaching about an apparatus provided with a plurality of functionalities, characterized in that it is formed by a server device for supplying questions concerning the possibilities of said apparatus, for attributing points to each user of the server device and for determining a reward for the users who have the most points.

2. A system as claimed in claim 1, for which said apparatus is provided with telecommunication means, characterized in that said means are used for a connection with said server device.

3. A system as claimed in claim 1 or 2, characterized in that the server device has profile means for determining the profile of the user.

4. A system as claimed in one of claims 1 to 3, characterized in that the server device has statistical means for determining the preferred functionalities of the users with a view to developing them on a future apparatus.

5. A system as claimed in claim 4, characterized in that, for functionalities, an interest criterion is associated.

6. An apparatus used in a system as claimed in one of claims 1 to 5.

7. An apparatus whose functionalities are defined by a system as claimed in one of claims 1 to 5.

8. A method for enhancing with users an apparatus having a plurality of functionalities, characterized in that it includes the following steps of:
putting on a server, of the Internet type in particular, a questionnaire concerning the use of the apparatus,
establishing a score for the correct responses to the questions in said questionnaire,
rewarding the best users, based on said score.

9. A method as claimed in claim 8, characterized in that it also includes an additional step for indicating the interest of the functionalities with a view to developing them on a future apparatus.
